(19) United States
(12) Patent Application Publication
(10) Pub. No.: US 2025/0200216 A1
(43) Pub. Date: Jun. 19, 2025

(54) SETTING ASSISTANCE DEVICE, SETTING ASSISTANCE METHOD AND NON-TRANSITORY COMPUTER-READABLE RECORDING MEDIUM ENCODED WITH SETTING ASSISTANCE PROGRAM

(71) Applicant: Konica Minolta, Inc., Tokyo (JP)

(72) Inventor: Megumi Watai, Osaka (JP)

(73) Assignee: Konica Minolta, Inc., Tokyo (JP)

(21) Appl. No.: 18/976,867

(22) Filed: Dec. 11, 2024

(30) Foreign Application Priority Data
Dec. 13, 2023 (JP) 2023-210186

(51) Int. Cl. G06F 21/62

(52) U.S. Cl. CPC G06F 21/6245

(57) ABSTRACT

A hardware processor included in a setting assistance device generates a work tenant including part of setting data defined by a preregistered client tenant, accepts update data obtained by adding, changing, or deleting data in the work tenant, and updates a client tenant with the update data.

### CROSS-REFERENCE TO RELATED APPLICATIONS

The entire disclosure of Japanese patent Application No. 2023-210186 filed on Dec. 13, 2023, is incorporated herein by reference in its entirety.

### BACKGROUND OF THE INVENTION

### Technical Field

The present invention relates to a setting assistance device, a setting assistance method and a non-transitory computer-readable recording medium encoded with a setting assistance program. In particular, the present invention relates to a setting assistance device that assists setting of a tenant formed by a computer, a setting assistance method to be executed by the setting assistance device and a non-transitory computer-readable recording medium encoded with a setting assistance program that causes a computer to execute the setting assistance method.

### Description of Related Art

With the spread of cloud service, users can use applications provided by service providers by using a tenant provided by the cloud service. The tenant is managed by a computer in association with a client account allocated to a client who receives the cloud service. The tenant includes a computer resource, an application, and a storage that are provided by the cloud service and allocated to the client account. The tenant also includes a task in which the computer executes an application program, and a data base to be generated by the task. In regard to the cloud service, in addition to setting values for access right and security, setting values for the application are set for each tenant independently of other tenants.

On the other hand, setting work for the tenant may be a burden on the client. Therefore, a customer engineer who is a service provider may assist the setting work for the tenant of the client. For example, Japanese Unexamined Patent Publication No. 2021-5806 describes an information processing system including an information processing server and a client terminal, wherein the information processing system includes an application storage that stores an application to be used by the client terminal, an application information manager that stores data representing whether the application can refer to a maintenance account, an account information manager in which an account of a client affiliated to a tenant and the maintenance account are registered, and a tenant account processor that executes a process for controlling whether to display or not display the maintenance account on the application on the client terminal, based on the data representing whether the application can refer to the maintenance account.

However, in the information processing system according to Japanese Unexamined Patent Publication No. 2021-5806, because a customer engineer logs into a tenant of a client with a maintenance account, confidential information included in the tenant may leak.

### SUMMARY OF THE INVENTION

In order to achieve the above-mentioned object, according to one aspect of the present invention, a setting assistance device includes a hardware processor, wherein the hardware processor generates a work tenant including part of setting data defined by a preregistered client tenant, accepts update data obtained by adding, changing, or deleting data in the work tenant, and updates the client tenant with the update data.

According to another aspect of the present invention, a setting assistance method causes a setting assistance device to execute a tenant generating step of generating a work tenant including part of setting data defined by a preregistered client tenant, an update data accepting step of accepting update data obtained by adding, changing, or deleting data in the work tenant, and an updating step of updating the client tenant with the update data.

According to yet another aspect of the present invention, a non-transitory computer-readable recording medium is encoded with a setting assistance program that causes a computer to execute a tenant generating step of generating a work tenant including part of setting data defined by a preregistered client tenant, an update data accepting step of accepting update data obtained by adding, changing, or deleting data in the work tenant, and an updating step of updating the client tenant with the update data.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating one example of the overview of a service provision system in one embodiment of the present invention;

FIG. 2 is a block diagram illustrating one example of the outline of the hardware configuration of a server in the present embodiment;

FIG. 3 is a block diagram illustrating one example of the functions of a central processing unit (CPU) included in the server in the present embodiment;

FIG. 4 is a diagram illustrating one example of a tenant table;

FIG. 5 is a block diagram illustrating one example of the detailed functions of a tenant manager;

FIG. 6 is a diagram illustrating one example of a user table;

FIG. 7 is a view illustrating one example of a setting information table;

FIG. 8 is a block diagram illustrating one example of detailed functions of a change subject portion acceptor;

FIG. 9 is a diagram illustrating one example of a flow of the maintenance work for a client tenant;

FIG. 10 is a diagram illustrating one example of a tenant specifying screen among operation screens output by a website;

FIG. 11 is a diagram illustrating one example of a change subject portion accepting screen among the operation screens output by the website;

FIG. 12 is a diagram illustrating one example of a confirmation screen among the operation screens output by the website;

FIG. 13 is a diagram illustrating one example of a notification screen among the operation screens output by the website;

FIG. 14 is a diagram illustrating one example of a client work tenant setting screen among the operation screens output by the website;

FIG. 15 is a diagram illustrating one example of an end instruction screen among the operation screens output by the website;

FIG. 16 is a flowchart illustrating one example of a flow of work tenant generation;

FIG. 17 is a flowchart illustrating one example of a flow of a maintenance process;

FIG. 18 is a flowchart illustrating one example of a flow of a client tenant updating process;

FIG. 19 is a diagram illustrating one example of a table for an address book registered in the client tenant;

FIG. 20 is a first diagram illustrating one example of a table for an address book registered in a work tenant;

FIG. 21 is a second diagram illustrating one example of the table for the address book registered in the work tenant; and

FIG. 22 is a diagram illustrating one example of a table for an address book registered in an updated client tenant.

### DETAILED DESCRIPTION

Hereinafter, one or more embodiments of the present invention will be described with reference to the drawings. However, the scope of the invention is not limited to the disclosed embodiments.

Embodiments of the present invention will be described below with reference to the drawings. In the following description, the same components are denoted by the same reference numerals. Their names and functions are also the same. Therefore, a detailed description thereof will not be repeated.

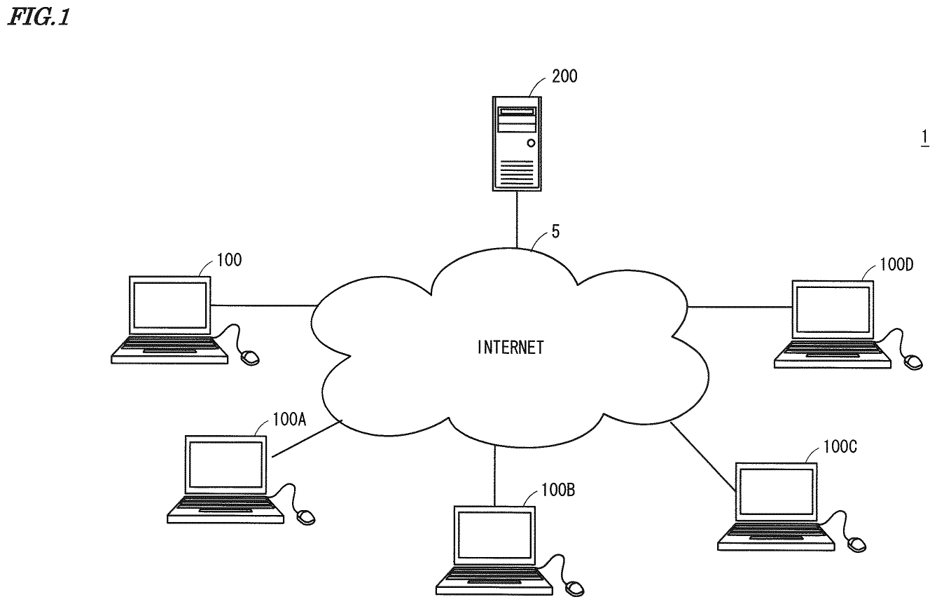

FIG. 1 is a diagram illustrating one example of the overview of a service provision system in one embodiment of the present invention. With reference to FIG. 1, the service provision system 1 includes a plurality of personal computers (hereinafter referred to as “PCs”) 100, 100A to 100D, and a server 200. Here, the service provision system 1 includes five PCs 100, 100A to 100D, by way of example. The hardware configurations and functions of the PCs 100, 100A to 100D are the same, and the PC 100 will be described as an example unless otherwise specified. Note that the hardware configurations of the PCs 100, 100A to 100D may be different from one another. Each of the PCs 100, 100A to 100D, and the server 200 is connected to the Internet 5. Thus, the PCs 100, 100A to 100D, and the server 200 can communicate with one another. Note that the Internet 5 may be a network such as a Local Area Network (LAN).

The server 200 is owned by a service provider that provides a cloud service and functions as a service provision device and a setting assistance device. An application program is installed in the server 200, and the server 200 provides a service by executing the application program. Here, suppose that four clients A to D have respectively registered client tenants A to D in the cloud service. In this case, the server 200 allocates part of computer resources and applications in the server 200 to the client tenants A to D. The server 200 respectively allocates four client accounts to the clients A to D. The server 200 generates the client tenants A to D respectively corresponding to the four client accounts to manage them. In the following description, a customer engineer of the service provider updates setting data in regard to the client tenant A of the client A, by way of example. The customer engineer of the service provider operates the PC 100, and the four clients A to D who receive provision of cloud services respectively operate the PCs 100A to 100D, by way of example.

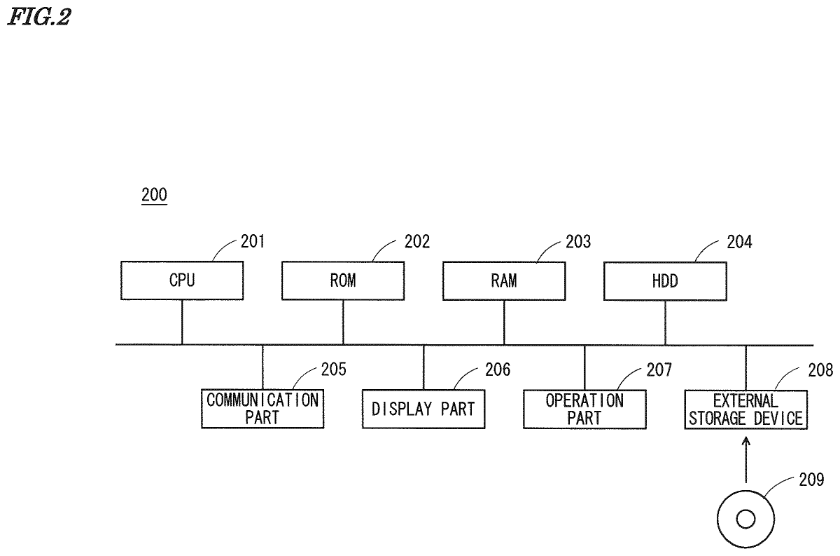

FIG. 2 is a block diagram illustrating one example of the outline of the hardware configuration of a server in the present embodiment. With reference to FIG. 2, the server 200 includes a hardware processor comprising a central processing unit (CPU) 201 for controlling the server 200 as a whole, a read-only memory (ROM) 202, a random-access memory (RAM) 203, a Hard Disc Drive (HDD) 204, a communication part (or communication interface) 205, a display part 206, an operation part (or operation device) 207 and an external storage device 208.

The ROM 202 stores a program to be executed by the CPU 201. The RAM 203 is used as a work area for the CPU 201. The HDD 204 is a mass storage device that stores data in a nonvolatile manner. Instead of the HDD 204, a Solid State Drive (SSD) may be used. The communication part 205 connects the CPU 201 to the Internet 5. The operation part 207 accepts an input operation performed by a user. Although not limited, the display part 206 is a Liquid Crystal Display Device. Note that an organic electroluminescence (EL) display may be used instead of a Liquid Crystal Display Device.

A Compact Disk Read Only Memory (CD-ROM) 209 is mounted on the external storage device 208. In the present embodiment, the CPU 201 executes the program stored in the ROM 202, by way of example. However, the CPU 201 may control the external storage device 208, read a program to be executed by the CPU 201 from the CD-ROM 209 and store the read program in the RAM 203 for execution.

A recording medium for storing the program to be executed by the CPU 201 is not limited to the CD-ROM 209 but may be a flexible disc, a cassette tape, an optical disc (Magnetic Optical Disc (MO)/Mini Disc (MD)/Digital Versatile Disc (DVD)), an IC card, an optical card, or a semiconductor memory such as a mask ROM or an Erasable Programmable ROM (EPROM). Further, the CPU 101 may load a program stored in the HDD 204 into the RAM 203 and execute the program. The program stored in the HDD 204 includes a program downloaded by the CPU 201 from a computer connected to the Internet, or a program written in the HDD 204 by a computer connected to the Internet. The program referred to here includes not only a program directly executable by the CPU 201 but also a source program, a compressed program, an encrypted program or the like.

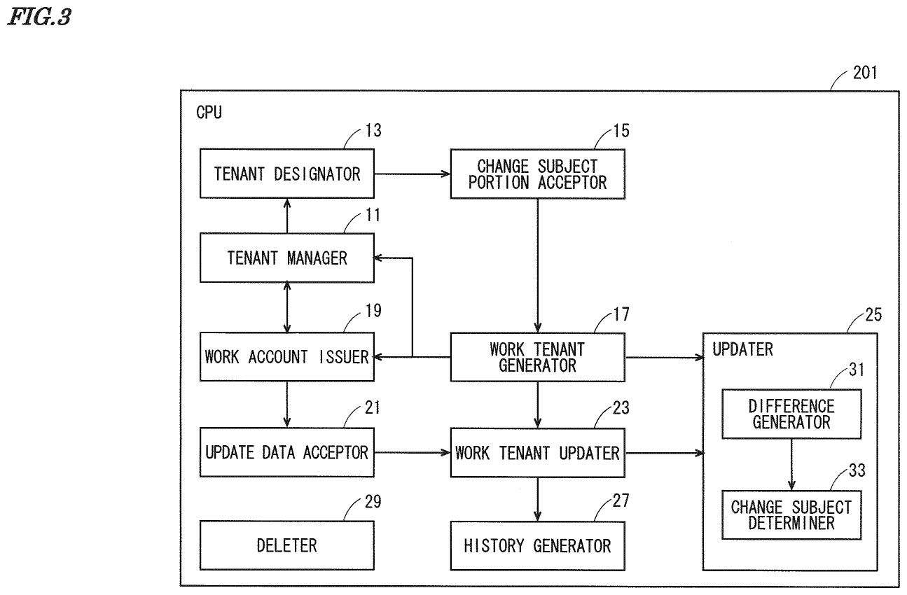

FIG. 3 is a block diagram illustrating one example of the functions of the CPU included in the server in the present embodiment. The functions illustrated in FIG. 3 may be implemented in hardware. Further, they may be implemented in the CPU 201 included in the server 200 by execution of the setting assistance program stored in the ROM 202, the HDD 204 or the CD-ROM 209 by the CPU 201. With reference to FIG. 3, the CPU 201 included in the server 200 has a tenant manager 11, a tenant designator 13, a change subject portion acceptor 15, a work tenant generator 17, a work account issuer 19, an update data acceptor 21, a work tenant updater 23, an updater 25, a history generator 27 and a deleter 29.

The tenant manager 11 manages the client tenants A to D. The tenant manager 11 stores, in the HDD 204, a database corresponding to each of the client tenants A to D. A tenant table for identifying four databases respectively corresponding to the client tenants A to D is stored in the HDD 204.

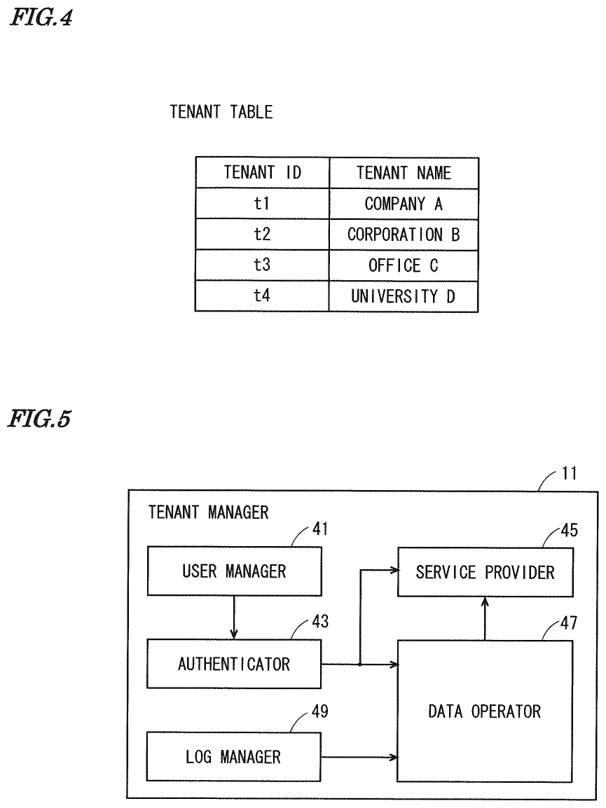

FIG. 4 is a diagram illustrating one example of the table. With reference to FIG. 4, the tenant table includes tenant records respectively corresponding to the client tenants A to D. Each of the tenant records includes an item for a tenant ID and an item for a tenant name. In the item for a tenant ID, identification information for identifying a tenant is set. Here, a tenant ID “t1” is allocated to the tenant A, a tenant ID “t2” is allocated to the tenant B, a tenant ID “t3” is allocated to the tenant C, and a tenant ID “t4” is allocated to the tenant D. In the item for a tenant name, a name provided to a tenant is set. A tenant name “COMPANY A” is allocated to the tenant A, a tenant name “CORPORATION B” is allocated to the tenant B, a tenant name “OFFICE C” is allocated to the tenant C, and a tenant name “University D” is allocated to the tenant D.

FIG. 5 is a block diagram illustrating one example of the detailed functions of a tenant manager. With reference to FIG. 5, the tenant manager 11 includes a user manager 41, an authenticator 43, a service provider 45, a data operator 47 and a log manager 49.

The user manager 41 manages a user who uses the server 200. The user manager 41 issues an account and stores, in the HDD 204, user management information that associates the account to a password. Here, the user manager 41 generates the user management information for each of the clients A to D, and the user management information is stored in the HDD 204, by way of example. The user manager 41 also issues an account to the customer engineer and stores the user management information corresponding to the customer engineer in the HDD 204.

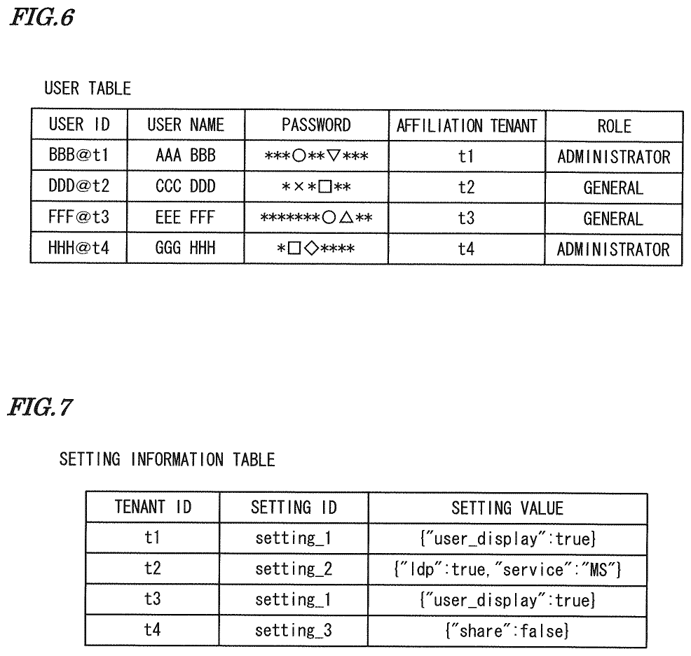

FIG. 6 is a diagram illustrating one example of a user table. The user table includes the user management information. With reference to FIG. 6, the user table includes user records respectively corresponding to the clients A to D. Each of the user records includes an item for a user ID, an item for a user name, an item for a password, an item for an affiliation tenant and an item for a role. In the item for the user ID, the user ID that is issued for each of the client tenants A to D is set. In the item of the user name, the name of each of the clients A to D is set. In the item for the affiliation tenant, the tenant ID of a client tenant to which a client is affiliated is set. In the item for the role, the authority allocated to the user identified by a user ID set in the item for the user name is set. Here, in the item for the role, one of administrator authority and general authority is set. With the administrator authority, the authority for performing an input operation for all settings with respect to the client tenant is allocated. Although the authority for performing an input operation for part of the settings with respect to the client tenant is allocated with general authority, the authority for performing other input operations is not allocated. For example, the user management information for a user ID “BBB [0024] t1” is set with respect to the client tenant A, and the client tenant A of the tenant ID “t1” and the administrator authority are allocated to the user management information.

Referring back to FIG. 5, the authenticator 43 authenticates a user who logs into a service. The authenticator 43 authenticates the user by using the user management information stored in the HDD 204. In a case where the communication part 205 receives an account and a password from one of the PCs 100, 100A to 100D, the authenticator 43 authenticates the user on the condition that the user information associating the received account with the received password is stored in the HDD 204. The authenticator 43 outputs the account of the authenticated user to the service provider 45 and the data operator 47.

The service provider 45 provides a service to the account received from the authenticator 43. The service here includes the service of providing a client tenant in addition to the service of allocating computer resources and a storage. The client tenant is a service that executes an application program. The content of the service to be provided by the client tenant is defined by the service provider. Various setting values are defined for the application program. The service provider 45 stores, in the HDD 204, a setting information table that defines a setting value for each client tenant.

The service provider 45 executes an application program in accordance with a setting value set in the setting information table. This setting value is defined for a client account, and different setting values are set for different client accounts. Therefore, although the service provider 45 executes the same application program for a plurality of client accounts, different processes may be executed for the plurality of client accounts. Here, the application program defines a process of managing a user, a process of managing an address book, and a process of transmitting data to an address registered in the address book, by way of example. The process of managing the user includes a process of managing a user who accesses a client tenant and a process of setting another authentication server.

FIG. 7 is a view illustrating one example of a setting information table. With reference to FIG. 7, the setting information table includes the setting information records respectively corresponding to the clients A to D. A setting information record includes an item for a tenant ID, an item for a setting ID and an item for a setting value. In the item for the tenant ID, the tenant ID of a client tenant is set. In the item for the setting ID, the identification information for identifying a setting value is set. In the item for the setting value, the setting value that is set in the client tenant is set. In regard to the setting value set for the client tenant, the setting value that is set in the item for the setting value includes only a setting value that has been added to an initially set setting value, a setting value obtained when an initially set setting value is changed, or an initially set setting value that has been deleted. All of the client tenants A to D are generated by, with a common initial tenant used as an initial state, changing the setting value that has been set for the initial tenant. Thus, a setting value different from the setting value that has been set for the initial tenant, among setting values set for the client tenant, is set in the item for the setting value.

Referring back to FIG. 5, the data operator 47 receives an operation corresponding to an account received from the authenticator 43, and operates the database corresponding to the account. A database is composed of one or more tables and one or more records included in the table. A table defines the format of the records. The records include a plurality of items defined based on the format defined by the table. The data operator 47 adds, changes, or deletes the table in accordance with an operation. The adding is a process of generating a new table. The changing is a process of changing the format of the records. The deleting is a process of deleting the table. Further, the data operator 47 adds, changes, or deletes the records in accordance with an operation. The adding is a process of adding a new record to the table. The changing is a process of changing at least one value for the items included in the records without changing the format. The deleting is a process of deleting an existing record.

For example, the client A operates the PC 100 to access the server 200 using an account A and a password A that are allocated to the client A, thereby being able to access a client tenant. Because being able to access the database corresponding to the client tenant, the client A can change the database, etc. Further, the client A can transmit data to an address registered in the database.

The log manager 49 stores history information in the HDD 204 in response to addition, change, or deletion of the table or the records by the data operator 47. History information includes the date/month/year, the user identification information of a user who has provided an instruction for performing an operation, and the process identification information for identifying a process executed by the operation. Further, history information may include the state of data before and after execution of the process corresponding to the operation.

Referring back to FIG. 3, the client tenants A to D respectively corresponding to the clients A to D are generated by the tenant manager 11, and the client tenants A to D are managed. The clients A to D may not have a thorough knowledge about an application program to be executed by the server 200, and may have difficulty in setting a setting value required for execution of the application program. Further, a client may wish to request another person to add, change, or delete a table or an item for a record, registered in the database corresponding to a client tenant, or to add a record to, change a record in, or delete a record from the table. The customer engineer of the service provider performs the changing work on behalf of the clients A to D. Here, the client A requests the customer engineer to perform the changing work, by way of example.

The tenant designator 13 designates a client tenant that is subjected to a process. In response to a request made by the customer engineer who has received a request for the maintenance work from the client A, the tenant designator 13 designates the client tenant A allocated to the client A as a process subject. The tenant designator 13 accepts designation of the client tenant A in a case where the customer engineer operates the PC 100 to log into the server 200 and inputs the tenant ID of the client tenant A. The tenant designator 13 may accept a request from the client A in a case where the client A operates the PC 100A to log into the server 200 and inputs an instruction for requesting the customer engineer to perform the changing work. The tenant designator 13 outputs a tenant ID for identifying the client tenant subjected to the process, which is the tenant ID of the client tenant A here, to the change subject portion acceptor 15.

The change subject portion acceptor 15 accepts a change subject portion. The change subject portion acceptor 15 accepts a change subject portion which is input by the customer engineer who operates the PC 100. The change subject portion acceptor 15 accepts a change subject portion of the setting data set in the client tenant. The setting data includes function specifying data for specifying the function of the client tenant, and actual data registered in the client tenant. The function specifying data includes an item for a setting value of an application program and definition information of a database. The definition information of the database includes format data that defines a data format. The format data includes information defining one or more tables included in the database. The information defining the tables includes information defining the items of the records registered in the table. The actual data includes a record registered in the table specified (or identified) by the function specifying data.

The change subject portion acceptor 15 accepts a change subject portion in accordance with an input operation performed by the customer engineer. The change subject portion acceptor 15 outputs the accepted change subject portion and the tenant ID of the client tenant A subjected to a process to the work tenant generator 17. The change subject portion acceptor 15 may transmit the change subject portion to the client A. On the condition that the change subject portion acceptor 15 accepts permission from the client A, the change subject portion acceptor 15 may output the change subject portion and the tenant ID of the client tenant A to the work tenant generator 17. Note that the change subject portion acceptor 15 may accept a change subject portion in accordance with an input operation performed by the client A. The change subject portion acceptor 15 outputs the accepted change subject portion and the tenant ID of the client tenant A subjected to the process to the work tenant generator 17.

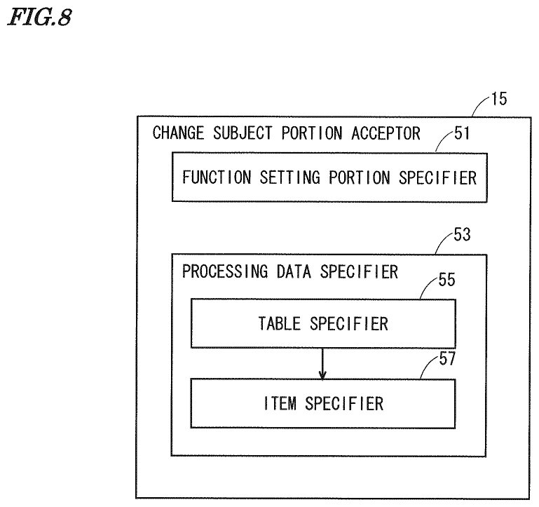

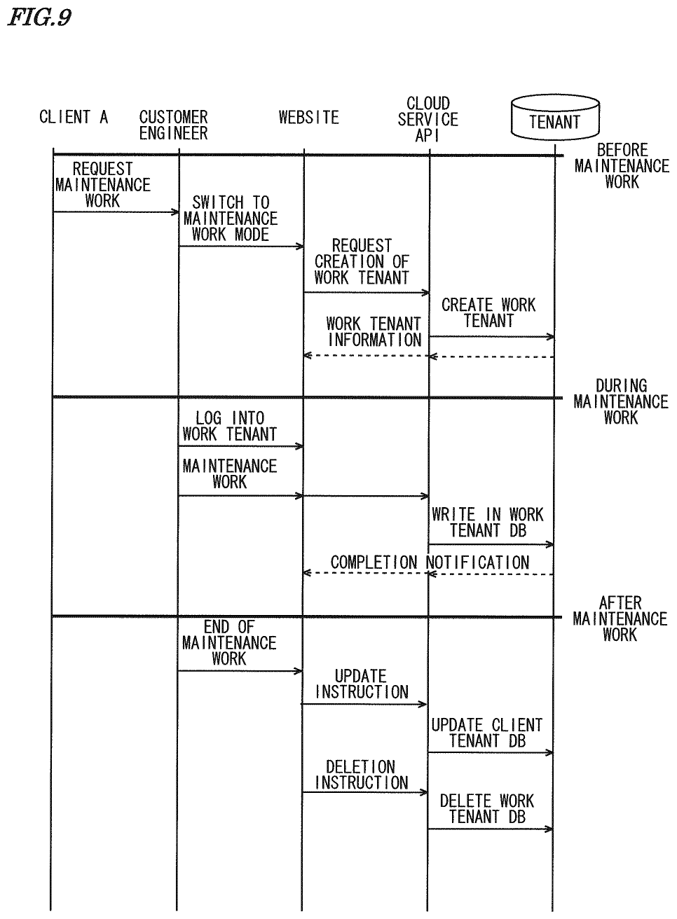

FIG. 8 is a block diagram illustrating one example of the detailed functions of the change subject portion acceptor. With reference to FIG. 9, the change subject portion acceptor 15 includes a function setting portion specifier 51 and a processing data specifier 53. The function setting portion specifier 51 accepts the function specifying data. The definition information of the database includes the table registered in the database and the items for the records defining the format of the table. Further, the definition information of the database includes relation information that defines the relevance among a plurality of tables. In a case where a new table is added to the database, when an item for a record defined by an existing table is added, changed, or deleted, the table identification information for identifying the table is included.

The customer engineer can change the definition information of the database specified (or identified) by the function setting portion specifier 51. In a case where a client requests the customer engineer to add a new table, or add, change, or delete an item for a record of an existing table, the customer engineer can change the definition information of the database specified by the function setting portion specifier 51. In a case where a client requests the customer engineer to perform setting relating to authentication by an authentication server, a setting value with low confidentiality such as a Uniform Resource Locator (URL) of the authentication server, or a setting item or the like of an authentication protocol is set in a change subject portion, and confidential information such as a password is not set in the change subject portion. Thus, it is possible to prevent leakage of confidential information such as a password.

The processing data specifier 53 accepts the information for specifying actual data. The actual data includes a record registered in the table specified by the function specifying data. The processing data specifier 53 includes a table specifier 55 and an item specifier 57. The table specifier 55 accepts table identification information for identifying any one of one or more tables registered in the database. When a table is specified by the function setting portion specifier 51, the table specifier 55 accepts the table identification information specified by the function setting portion specifier 51. The processing data specifier 53 determines, as a change subject portion, a record registered in the table specified (or identified) by the table identification information accepted by the table specifier 55.

The item specifier 57 specifies (or identifies) at least one of the items for the records defined by the table specified by the table identification information accepted by the table specifier 55. In a case where the records defined by the table include a plurality of items, only part of the items may be specified. The processing data specifier 53 specifies, as a change subject portion, the partial data including only a value set in one or more items of a record specified by the item specifier 57 among the actual data registered in the table specified by the table specifier 55. In the table defining an address book, a record includes the items for a registration number, a name, age, an address and an e-mail address, by way of example. In this case, the actual data (partial data) that do not include a name or age but includes only the items for a registration number, an address and an e-mail address is specified as the change subject portion. A client provides the customer engineer with a list including a registration number, an address and an e-mail address, by way of example. In this case, the customer engineer can perform work for inputting the actual data including the registration number, the address and the e-mail address into the table specified by the table specifier 55. Because the change subject portion does not include a name or age, it is possible to prevent leakage of confidential information.

Referring back to FIG. 3, the work tenant generator 17 generates a work tenant corresponding to the client tenant A, based on a change subject portion and a tenant ID. The work tenant generator 17 registers the work tenant in the tenant manager 11, and outputs the tenant ID of the work tenant to the work account issuer 19, the work tenant updater 23, and the updater 25.

The work tenant generator 17 generates, as a work tenant, the tenant including only the change subject portion of the client tenant A identified by the tenant ID. In a case where the change subject portion includes the item for a setting value of an application program, the work tenant generator 17 generates a tenant including the item for the setting value as a work tenant. The work tenant does not include the item for a setting value of an application program that is not set in the change subject portion. Therefore, a work tenant can be prevented from including the item for a highly confidential setting value of an application program. This prevents leakage of confidential information.

In a case where a change subject portion includes an item for a record of a table registered in a database, the work tenant generator 17 generates, as a work tenant, a tenant including partial data made of a record including only a value set in the item for the record included in the change subject portion. A work tenant does not include a value set in an item for a record, which is not included in the change subject portion, among records registered in the table. Therefore, in a case where a change subject portion is set such that confidential information is not included in the change subject portion, a work tenant does not include confidential information included in the client tenant A. This prevents leakage of confidential information.

The work account issuer 19 issues a work account in response to input of the tenant ID of a work tenant. A work account includes a user ID and a password allocated to the work tenant. The work account issuer 19 notifies the client A of the work account. In a case of making a change request to the customer engineer, the client A notifies the customer engineer of the work account. Furthermore, the work account issuer 19 outputs the work account to the update data acceptor 21.

The update data acceptor 21 accepts update data, which the customer engineer inputs to the work tenant. The customer engineer operates the PC 100 to access the server 200 using the work account. Thus, the changing work can be performed on the work tenant registered by the tenant manager 11. In a case of accepting update data, the update data acceptor 21 outputs the update data to the work tenant updater 23.

The work tenant updater 23 updates the work tenant based on the update data. Specifically, the work tenant updater 23 causes the update data to be reflected in the work tenant managed by the tenant manager 11. In a case where the update data includes a setting value of an application program, the work tenant updater 23 rewrites a value of the item for the setting value with the update data. In a case where the update data is the data for changing the definition information of a database, the work tenant updater 23 changes the definition information of the database. In a case where the update data is the data for adding, changing, or deleting a record set in a table registered in a database, the work tenant updater 23 adds, changes, or deletes the record set in the table registered in the database. Thus, in the tenant manager 11, the setting information table corresponding to the work tenant is updated.

In response to completion of update of the work tenant, the work tenant updater 23 outputs an update instruction to the updater 25. Specifically, an instruction for referring to the setting information table corresponding to the updated work tenant is output to the updater 25. Further, the work tenant updater 23 outputs the input date and time of the update data, and the update data to the history generator 27. The history generator 27 stores the update date and time and the update data as update history information in the HDD 204.

The updater 25 updates the client tenant A with reference to the work tenant. The updater 25 includes a difference generator 31 and a change subject determiner 33. The difference generator 31 generates the difference between the client tenant A and the work tenant. Specifically, the difference between the setting information corresponding to the client tenant A registered in the setting information table stored in the HDD 204 and the setting information corresponding to the work tenant is extracted as difference information. The difference generator 31 outputs the difference information to the change subject determiner 33. The setting information represents the difference from a setting value in an initial state of a tenant. Because both of the setting information corresponding to the client tenant A and the setting information corresponding to the work tenant represent the differences from the same criterion, the difference between the setting information corresponding to the client tenant A and the setting information corresponding to the work tenant represents the difference between the client tenant A and the work tenant.

The change subject determiner 33 determines whether the difference information includes only a change subject portion. In a case where the difference information includes a portion other than the change subject portion, error information is generated and output. For example, the change subject determiner 33 generates an email including the error information and sends the e-mail to the client A.

In a case where the change subject determiner 33 determines that the difference information includes only the change subject portion, the updater 25 updates the client tenant with the difference information. Thus, the client tenant is updated to the state in which the client tenant is updated by the customer engineer.

The deleter 29 deletes the work tenant after the client tenant A is updated. In response to accepting an end instruction indicating that the work for inputting the update data performed by the customer engineer is completed, the deleter 29 deletes the work tenant. In this case, the work tenant can be deleted at the time when the work tenant becomes unnecessary. Further, the deleter 29 may delete the work tenant after a predetermined period elapses since the client tenant is updated with the update data. In this case, the work tenant can be deleted at the time when the work tenant becomes unnecessary. Further, in response to detection of log-out of the customer engineer, the deleter 29 may delete the work tenant. In this case, because the client tenant A has been updated with the work tenant, the work tenant can be deleted at the time when the process executed on the work tenant ends and the work tenant becomes unnecessary.

FIG. 9 is a diagram illustrating one example of a flow of the maintenance work for a client tenant. The flow of time is illustrated from the top to the bottom, and the respective flows of the work performed by the client A, the work performed by the customer engineer, a process to be executed on a website, a process to be executed in a cloud service Application Programming Interface (API) and a process to be executed in a tenant database (DB) are illustrated in order from the left to the right. The website is a portion where the server 200 functions as a web server, and serves as a user interface. The cloud service API is arranged between the website and the tenant DB, and is the interface with respect to an application program to be executed in a service provided by the server 200. Specifically, the cloud service API executes a process on the tenant DB in accordance with a user's instruction accepted on the website.

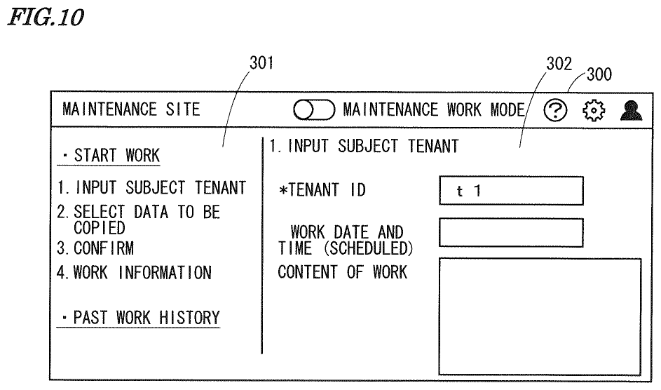

FIGS. 10 to 15 are diagrams illustrating one example of the operation screens output by the website. The flow of the maintenance work illustrated in FIG. 9 will be described below with reference to the operation screens illustrated in FIGS. 10 to 15. First, a flow of a process to be executed before the maintenance work for the client tenant A will be described.

The client A requests the customer engineer to perform the maintenance work. In response to the request, the customer engineer operates the PC 100 to instruct the website to switch to a maintenance work mode. At this stage, a tenant specifying screen 300 illustrated in FIG. 10 is displayed on the PC 100. The tenant specifying screen 300 includes an area 301 illustrating the work procedure and an area 302 for specifying a subject tenant. The area 301 illustrating the work procedure includes an option “1. INPUT SUBJECT TENANT” representing the first work for designating a tenant subjected to a process as a subject tenant. Further, the area 301 illustrating the work procedure includes an option “2. SELECTION DATA TO BE COPIED” representing the second work for designating a change subject portion. The area 301 representing the work procedure includes an option “3. CONFIRM” representing the third work for confirming the change subject portion. The area 301 representing the work procedure includes an option “4. WORK INFORMATION” representing the fourth work for adding, changing or deleting setting data.

The area 302 for specifying a subject tenant includes an area for setting a tenant ID, an area for setting the work date and time (scheduled), and an area for setting the content of work. A client tenant identified by the tenant ID set in the area for setting the tenant ID is designated as a process subject for creation of a work tenant. Here, the tenant A having the client ID “t1” is designated as the process subject, by way of example.

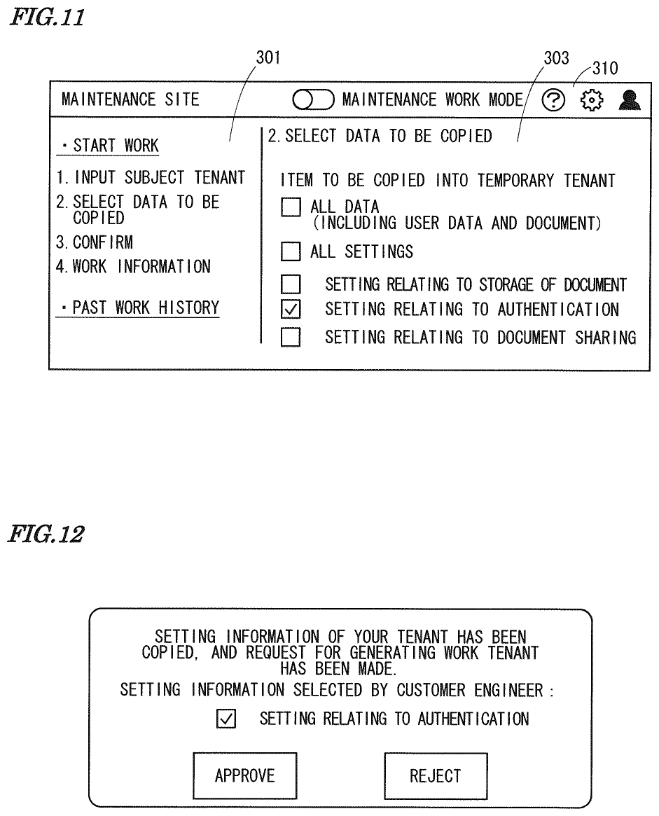

Next, in response to designation of the client tenant subjected to a process in the tenant specifying screen 300, the website outputs a change subject portion accepting screen 310 illustrated in FIG. 11 and causes the change subject portion accepting screen 310 to be displayed on the PC 100. The change subject portion accepting screen 310 includes the area 301 illustrating the work procedure and an area 303 specifying a change subject portion. The area 303 for specifying the change subject portion includes five check boxes. The five check boxes are exclusively selectable, and one of the five check boxes is selectable. Specifically, the first check box is selected in a case where all data is selected. The second check box is selected in a case where the setting values for all settings are selected. The third check box is selected in a case where a setting value relating to storage of a document is selected. The fourth check box is selected in a case where the setting relating to authentication is selected. The fifth check box is selected in a case where the setting relating to document sharing is selected. Here, the fourth check box for selecting the setting relating to authentication is selected, by way of example.

Next, in response to designation of the change subject portion by the change subject portion accepting screen 310, the website outputs a confirmation screen 320 illustrated in FIG. 12, and displays the confirmation screen 320 on the PC operated by a client who is the owner of a client tenant. Here, because the client tenant A is set as a process subject, the confirmation screen 320 is displayed on the PC 100A that is operated by the client A who is the owner of the client tenant A. The confirmation screen is the screen for requesting permission for generation of a work tenant from the customer engineer, and includes the information representing a change subject portion, a button in which the characters for “APPROVE” are illustrated, and a button in which the characters for “REJECT” are illustrated.

In response to designation of the button in which the characters for “APPROVE” are illustrated, the website requests the cloud service API to create a work tenant. The cloud service API creates a work tenant in response to the request, and the work tenant corresponding to the client tenant A is generated in the tenant DB. The cloud service API outputs work tenant information to the website. The work tenant information includes a tenant ID for identifying a work tenant, and an account and a password for accessing the work tenant.

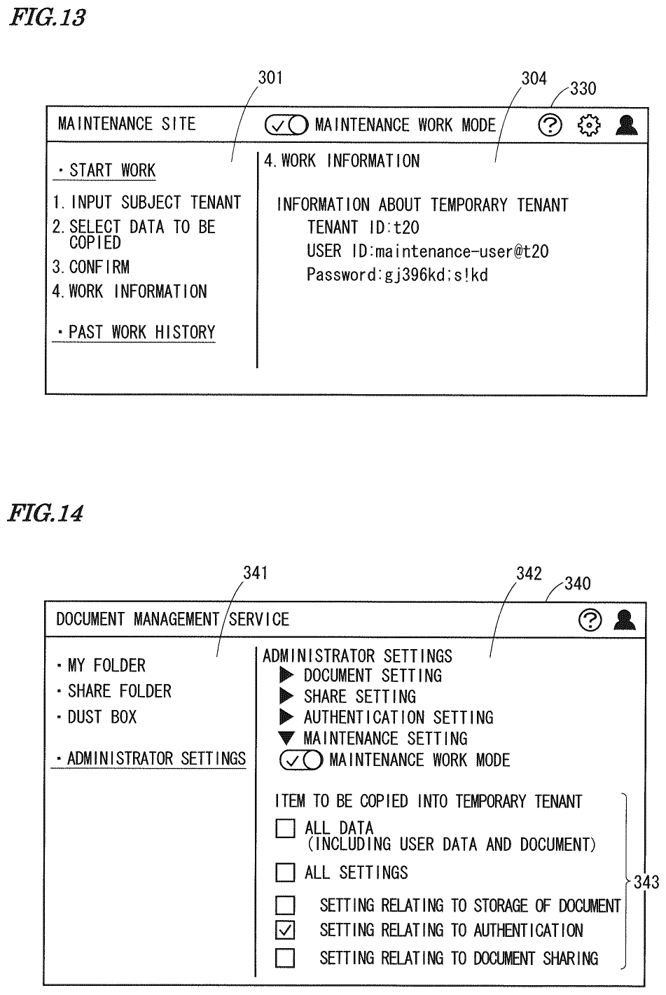

In response to receiving the work tenant information from the cloud service API, the website outputs a notification screen 330 illustrated in FIG. 13, and causes the PC 100 to display the notification screen 330. The notification screen 330 includes the area 301 for illustrating the work procedure and an area 304 for displaying work tenant information. In the area 304 for displaying work tenant information, the work tenant information is displayed. Therefore, the customer engineer can access the work tenant using a tenant ID, an account and a password included in the work tenant information.

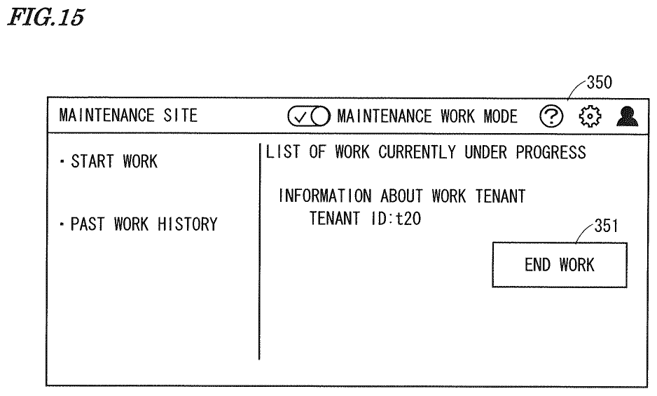

Here, the customer engineer who is not authorized to access the client tenant A can create a work tenant. However, the client A may generate a work tenant. In this case, the website outputs a client work tenant setting screen 340 illustrated in FIG. 14, and causes the PC 100A operated by the client A to display the client work tenant setting screen 340. The client work tenant setting screen 340 includes an area 341 in which a main menu is displayed, and an area 342 for accepting administrator settings. In response to designation of an item “ADMINISTRATOR SETTINGS” in the area 341 in which the main menu is displayed, the menu for the administrator settings is displayed in the area 342. The area 342 includes an item for a maintenance setting, and an area for setting the maintenance work mode includes an area 343 for identifying a change subject portion. The area 343 for specifying the change subject portion includes five check boxes. The five check boxes are exclusively selectable, and any one of the five check boxes is selectable. Specifically, the first check box is selected in a case where all data is selected. The second check box is selected in a case where the setting values for all settings are selected. The third check box is selected in a case where a setting value relating to storage of a document is selected. The fourth check box is selected in a case where the setting relating to authentication is selected. The fifth check box is selected in a case where the setting relating to document sharing is selected. Here, the fourth check box for selecting the setting relating to authentication is selected, by way of example.

In a case where a work tenant is generated according to the content set in the area 343 for specifying the change subject portion, the notification screen 330 illustrated in FIG. 13 is displayed on the PC 100A. If the client A notifies the customer engineer of the work tenant information via e-mail or the like, the customer engineer can access the work tenant by using a tenant ID, an account and a password included in the work tenant information.

Next, a flow of a process during maintenance work for a client tenant will be described. The customer engineer accesses a website using an account and a password issued for a work tenant, thereby logging into the work tenant. Then, the customer engineer inputs maintenance work to the website. The maintenance work includes adding, changing, or deleting data included in a work tenant. The website outputs the content of the maintenance work to the cloud service API. The cloud service API executes a process of adding, changing, or deleting setting data included in the work tenant in accordance with the content of the maintenance work, and notifies the website of completion of the process. Thus, the customer engineer can confirm that the maintenance work for the work tenant has been completed.

Next, a process flow after the maintenance work for a client tenant is completed will be described. The customer engineer instructs the website to end the maintenance work for a work tenant. The customer engineer instructs the website to end the maintenance work by designating a button 351 in which the characters for “END WORK” are displayed in an end instruction screen 350 illustrated in FIG. 15. In response to accepting the instruction provided by the customer engineer, the website outputs an update instruction to the cloud API. The cloud API updates the client tenant A with the work tenant in accordance with the update instruction. Thereafter, the website outputs a deletion instruction to the cloud API. The cloud API deletes the work tenant in accordance with the deletion instruction.

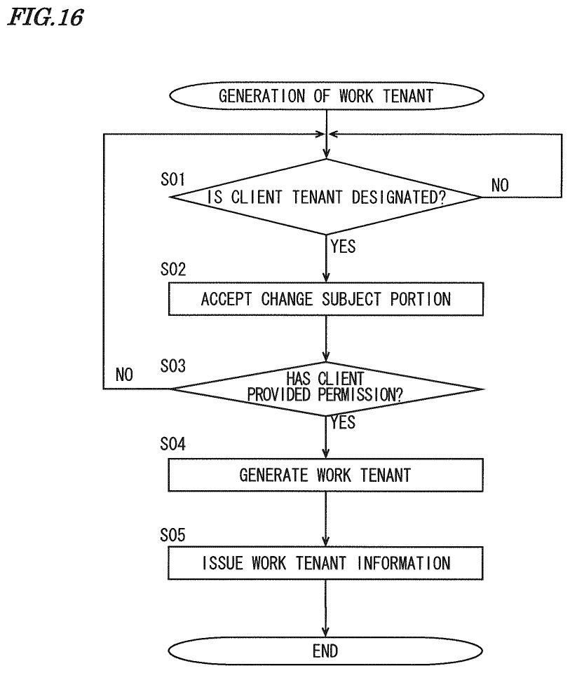

FIG. 16 is a flowchart illustrating one example of a flow of work tenant generation. A work tenant generation process is a process executed by the CPU 201 included in the server 200 when the CPU 201 executes a setting assistance program stored in the ROM 202, the HDD 204 or the CD-ROM 209. With reference to FIG. 16, the CPU 201 included in the server 200 determines whether a client tenant has been designated (step S01). When the customer engineer operates the PC 100 to designate a client tenant on the tenant specifying screen 300 of FIG. 10, designation of the client tenant is accepted. The process waits until a client tenant is designated (NO in the step S01). When a client tenant is designated (YES in the step S01), the process proceeds to the step S02. Here, the client tenant A is designated, by way of example.

In the step S02, a change subject portion is accepted, and the process proceeds to the step S03. The change subject portion accepting screen 310 illustrated in FIG. 11 is displayed on the PC 100, and a change subject portion that is input by the customer engineer in accordance with the change subject portion accepting screen 310 is accepted.

In the step S03, whether generation of a work tenant has been permitted by a client is determined. When the confirmation screen 320 illustrated in FIG. 12 is displayed on the PC 100A operated by the client A, the client A confirms the change subject portion displayed on the confirmation screen 320, and then the button in which the characters for “APPROVE” are illustrated is designated, permission from the client is accepted. In a case where the button in which the characters for “REJECT” are displayed is designated, permission from the client is not accepted. If permission from the client is provided, the process proceeds to the step S04. If not, the process returns to the step S01.

In the step S04, a work tenant is generated, and the process proceeds to the step S05. A work tenant to which the change subject portion, which is accepted in the step S02, in the client tenant A designated in the step S01 is copied is generated. The work tenant does not include a portion other than the change subject portion. Therefore, it is possible to prevent the work tenant from including confidential information.

In the step S05, work tenant information is issued, and the process ends. Specifically, the notification screen 330 illustrated in FIG. 13 is displayed on the PC 100 operated by the customer engineer. The notification screen 330 includes the area 304 for displaying work tenant information. Therefore, the customer engineer can access the work tenant using a tenant ID, an account and a password included in the work tenant information.

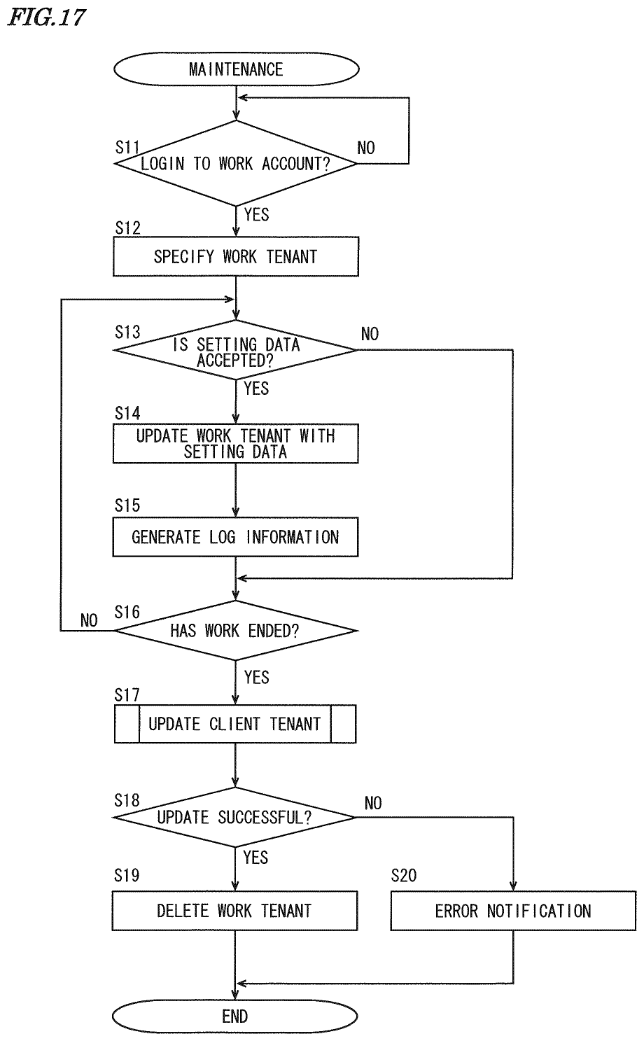

FIG. 17 is a flowchart illustrating one example of a flow of a maintenance process. The maintenance process is a process executed by the CPU 201 included in the server 200 when the CPU 201 executes a setting assistance program stored in the ROM 202, the HDD 204 or the CD-ROM 209. With reference to FIG. 17, the CPU 201 included in the server 200 determines whether a login to a work account has been made (step S11). The process waits until a login using the work account is detected (NO in the step S11). If the login using the work account is detected (YES in step S11), the process proceeds to the step S12.

In the step S11, a work tenant is identified, and the process proceeds to the step S12. The work tenant corresponding to the work account is identified as a process subject. In the step S13, it is determined whether setting data has been accepted. If the setting data has been accepted, the process proceeds to the step S14. If not, the process proceeds to the step S16.

In the step S14, the work tenant is updated with the setting data accepted in the step S13, and the processing proceeds to the step S15. In the step S15, the history of an updating process is generated as log formation, and the process proceeds to the step S16. The log information is stored in the HDD 204 in association with the work tenant, for example.

In the step S16, whether work has ended is determined. When the end instruction screen 350 illustrated in FIG. 15 is displayed on the PC 100 operated by the customer engineer, and the customer engineer designates the button 351 in which the characters for “END WORK” is illustrated in the end instruction screen 350, an end instruction is accepted. If the end instruction is accepted, the process proceeds to the step S17. If not, the process returns to the step S13.

In the step S17, a client tenant updating process is executed, and the process proceeds to the step S18. While details of the client tenant updating process will be described below, the client tenant updating process is a process of updating a client tenant with a work tenant.

In the step S18, whether the update is successful is determined. If the update of the client tenant is successful, the process proceeds to the step S19. If not, the process proceeds to the step S20. In the step 19, the work tenant is deleted, and the process ends. In the step S20, error notification is made, and the process ends. Error information representing that the client tenant has not been updated is transmitted to each of the PCs 100, 100A. Thus, the client A and the customer engineer can be informed that the update of the client tenant has failed.

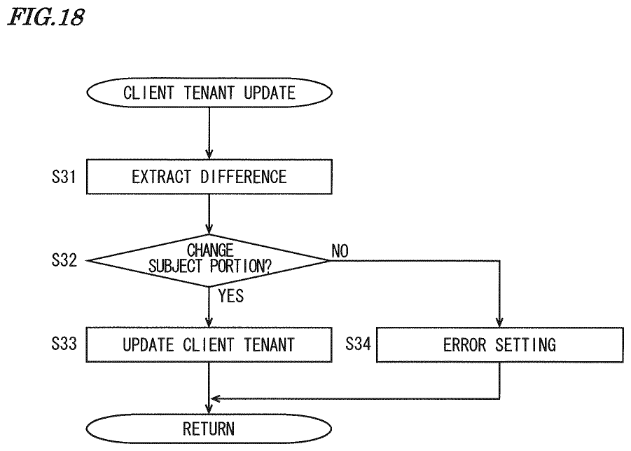

FIG. 18 is a flowchart illustrating one example of a flow of the client tenant updating process. The client tenant updating process is a process executed in the step S17 of the maintenance process. With reference to FIG. 18, the CPU 201 included in the server 200 extracts a difference, and the process proceeds to the step S32. The difference between the work tenant and the client tenant is extracted.

In the step S32, whether the difference is the change subject portion is determined. If the difference is the change subject portion, the process proceeds to the step S33. If not, the process proceeds to the step S34. In the step S33, the client tenant is updated with the work tenant, and “SUCCESSFUL” is set as a return value, and the process returns to the maintenance process. In the step S34, “ERROR” is set as the return value, and the process returns to the maintenance process.

### EXAMPLES

Examples in the service provision system 1 in the present embodiment will be described below. The customer engineer adds a new record to a table for an address book registered in the client tenant of the client A, by way of example.

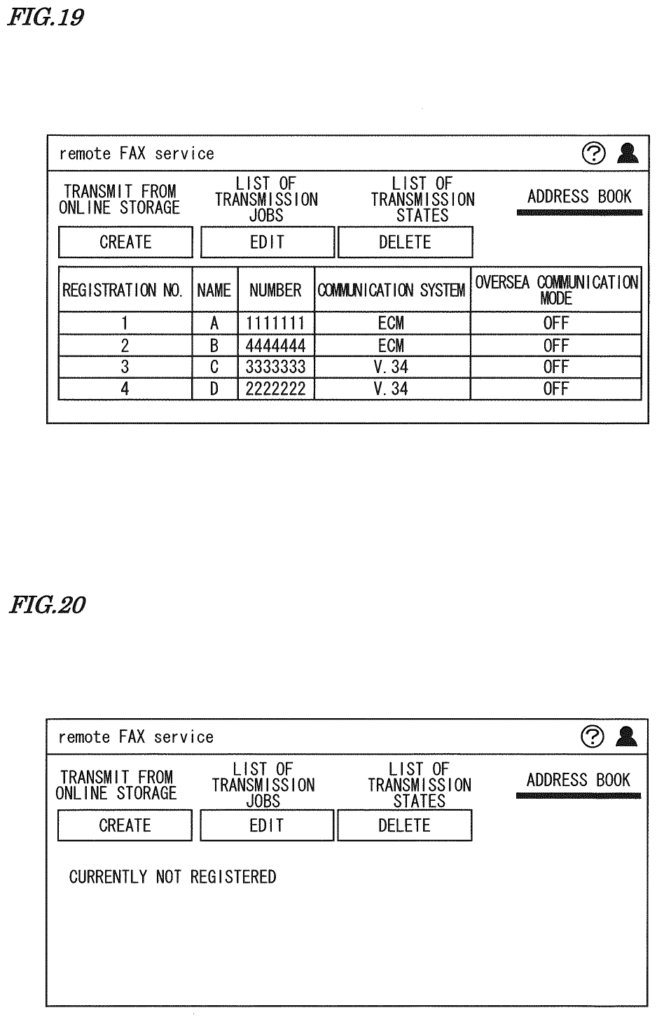

FIG. 19 is a diagram illustrating one example of a table for an address book registered in a client tenant. With reference to FIG. 19, the table for the address book includes four records. The records include an item for a registration number, an item for a name, an item for a number, an item for a communication system, and an item for an oversea communication mode. In the item for the registration number, identification information for identifying a record is set. In the item for the name, the name for the client A is set. In the item for the number, a facsimile number is set. In the item for the communication system, the system of facsimile communication is set. In the item for the overseas communication mode, whether the overseas communication mode is an ON state in which the overseas communication is available or an OFF state in which the overseas communication is not available is set.

The client A requests the customer engineer to add a new record to an address book registered in the client tenant A. In this case, a work tenant corresponding to the client tenant A is generated. Although the work tenant has the table for the address book, no record is registered.

FIG. 20 is a first diagram illustrating one example of a table for an address book registered in a work tenant. With reference to FIG. 20, the message “CURRENTLY NOT REGISTERED” is displayed, and it is illustrated that no record is registered in the table for the address book.

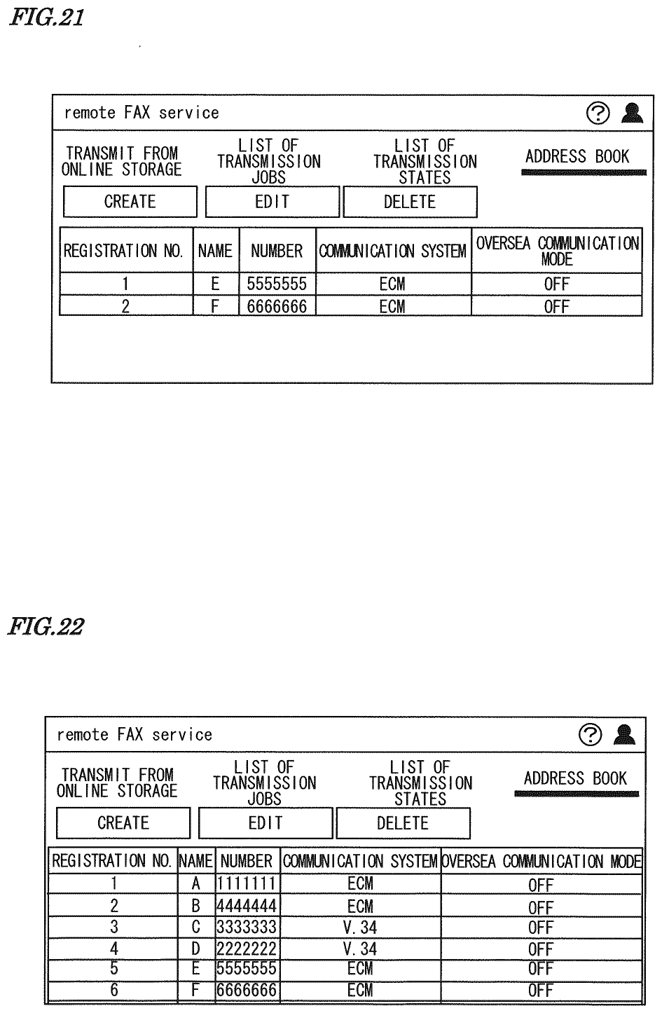

FIG. 21 is a second diagram illustrating one example of the table for the address book registered in the work tenant. FIG. 21 illustrates the table to which the customer engineer has newly added two records.

FIG. 22 is a diagram illustrating one example of a table for an address book registered in an updated client tenant. With reference to FIG. 22, the table for the address book includes six records including the two records illustrated in FIG. 21 in addition to the four records illustrated in FIG. 19.

In this manner, the client can newly register two records without having the customer engineer view the four records illustrated in FIG. 19. Thus, the customer engineer is not informed of the content of the four records.

### Modification Examples

In the above-mentioned embodiment, the server 200 deletes the work tenant after the client tenant A is updated with the work tenant. On the condition that an end instruction indicating the end of acceptance of update data is input by the customer engineer, the work tenant is deleted. Alternatively, the server 200 may delete the work tenant after a predetermined period elapses since the client tenant A is updated with the update data. Further, in response to detection of log-out of an account permitted to access the work tenant, the server 200 may delete the work tenant. In this case, the work tenant can be deleted at the time when the work tenant becomes unnecessary.

As described above, in the service provision system 1 in the present embodiment, the server 200 functions as the setting assistance device. The server 200 generates the work tenant including part of the setting data defined by the preregistered client tenant A, accepts the update data obtained when data is added, changed or deleted in the work tenant, and updates the client tenant A with the update data. The work tenant can be prevented from including the confidential information in the setting data defined by the client tenant A. Therefore, the customer engineer who adds, changes, or deletes the setting data in the work tenant can be prevented from acquiring the confidential information defined by the client tenant. Therefore, it is possible to construct or maintain the client tenant A while preventing leakage of the confidential information.

Further, the setting data defined by the client tenant A include the format data which is the definition information of the table and the actual data in the format defined by the format data. The server 200 generates the work tenant based on the format data of the client tenant A, and accepts addition, change, or deletion in regard to the definition information of the table and/or the actual data for the work tenant. Therefore, in the client tenant, the definition information of the database and/or the actual data can be added, changed, or deleted.

Further, the server 200 generates a work tenant that includes partial data made of a partial item designated as a change subject portion among a plurality of items defined by the format data of the table in the actual data defined by the client tenant A. Therefore, the work tenant includes the partial data made of the partial item designated as the change subject portion among the plurality of items in the actual data defined by the client tenant A, which can prevent leakage of the content of an item other than the partial item defined by the change subject portion.

Further, based on the difference between the generation-time setting data defined by the client tenant A at the time of generation of a work tenant and the initial setting data defined by the client tenant A in the initial state, the server 200 generates the work tenant. Therefore, the work tenant can be generated accurately.

Further, the server 200 generates the difference between the generation-time setting data defined by a work tenant at the time when the work tenant is generated and the update-time setting data defined by a work tenant at the time when the client tenant is updated. Therefore, the client tenant A can be updated with the portion that is added, changed or deleted in the work tenant.

Further, the server 200 accepts the change subject portion subjected to addition, change or deletion in the setting data defined by the work tenant A, and determines whether the update data applies to the change subject portion. Therefore, in a case where the update data does not apply to the change subject portion, the client tenant A is prevented from being updated.

Further, the server 200 stores the work history of the account that is permitted to access the work tenant. Therefore, the work content of addition, change, or deletion of the setting data can be confirmed after the update.

Further, the setting data includes the function specifying data for specifying the functions of the client tenant A and the actual data registered in the client tenant A. Therefore, the functions of the client tenant can be added, changed, or deleted. Further, because the setting data includes the actual data registered in the client tenant A, the actual data can be added, changed, or deleted.

Further, because the server 200 deletes the work tenant, the storage resources can be effectively utilized.

The server 200 deletes the work tenant on the condition that the end instruction indicating the end of acceptance of update data is accepted. Further, the server 200 may delete the work tenant after a predetermined period elapses since the client tenant A is updated with the update data. Further, in response to deletion of log-out of the account that is permitted to access the work tenant, the server 200 may delete the work tenant. The work tenant can be deleted at the time when the work tenant becomes unnecessary.

Although embodiments of the present invention have been described and illustrated in detail, the disclosed embodiments are made for purpose of illustration and example only and not limitation. The scope of the present invention should be interpreted by terms of the appended claims.

What is claimed is:

1. A setting assistance device comprising:
a hardware processor that:
generates a work tenant including part of setting data defined by a preregistered client tenant, accepts update data obtained by adding, changing, or deleting data in the work tenant, and updates the client tenant with the update data.

2. The setting assistance device according to claim 1, wherein
the setting data defined by the client tenant includes format data defining a format and actual data in the format defined by the format data, and
the hardware processor accepts addition, change, or deletion of at least one of the format data and the actual data.

3. The setting assistance device according to claim 2, wherein
the hardware processor generates the work tenant including partial data, and
the partial data are made of a designated partial item, among a plurality of items defined by the format data, of the actual data defined by the client tenant.

4. The setting assistance device according to claim 1, wherein
the hardware processor generates the work tenant based on a difference between generation-time setting data defined by the client tenant at a time when the work tenant is generated and initial setting data defined by the client tenant in an initial state.

5. The setting assistance device according to claim 1, wherein
the hardware processor generates a difference between generation-time setting data defined by the work tenant at a time when the work tenant is generated and update-time setting data defined by the work tenant at a time when the client tenant is updated.

6. The setting assistance device according to claim 1, wherein
the hardware processor:
further accepts a change subject portion of the setting data defined by the client tenant, the change subject portion being subjected to addition, change, or deletion, and
determines whether the update data applies to the change subject portion.

7. The setting assistance device according to claim 1, wherein
the hardware processor stores work history of an account that is permitted to access the work tenant.

8. The setting assistance device according to claim 1, wherein
the setting data includes function specifying data for specifying a function of the client tenant and actual data registered in the client tenant.

9. The setting assistance device according to claim 1, wherein
the hardware processor deletes the work tenant.

10. The setting assistance device according to claim 9, wherein
the hardware processor:
accepts an end instruction representing an end of acceptance of the update data, and deletes the work tenant on condition that the end instruction is accepted.

11. The setting assistance device according to claim 9, wherein
the hardware processor deletes the work tenant after a predetermined period elapses since the client tenant is updated with the update data.

12. The setting assistance device according to claim 9, wherein
the hardware processor deletes the work tenant in response to detection of log-out of an account permitted to access the work tenant.

13. A setting assistance method for a setting assistance device, the method comprising:
a tenant generating step of generating a work tenant including part of setting data defined by a preregistered client tenant;
an update data accepting step of accepting update data obtained by adding, changing, or deleting data in the work tenant; and
an updating step of updating the client tenant with the update data.

14. A non-transitory computer-readable recording medium encoded with a setting assistance program that causes a computer to execute:
a tenant generating step of generating a work tenant including part of setting data defined by a preregistered client tenant;
an update data accepting step of accepting update data obtained by adding, changing, or deleting data in the work tenant; and
an updating step of updating the client tenant with the update data.
